(19) United States
(12) Patent Application Publication
(10) Pub. No.: US 2017/0146894 A1
(43) Pub. Date: May 25, 2017

(54) HOLDING MEMBER AND IMAGING UNIT

(71) Applicant: SONY CORPORATION, TOKYO (JP)

(72) Inventors: TOMOYUKI KUBOTERA, TOKYO (JP); MASAHIDE FURUKAWA, TOKYO (JP); AKIHIRO BABA, KANAGAWA (JP); TSUYOSHI UMEMURA, KANAGAWA (JP); TOMOTSUGU MINAMIKAWA, TOKYO (JP)

(21) Appl. No.: 15/309,795

(22) PCT Filed: Mar. 16, 2015
(86) PCT No.: PCT/JP2015/001452

§ 371 Date: Nov. 8, 2016

(30) Foreign Application Priority Data
May 16, 2014 (JP) 2014-102228
Jun. 5, 2014 (JP) 2014-116595

(51) Int. Cl. G03B 17/56; F16M 13/04

(52) U.S. Cl. CPC G03B 17/563; F16M 13/04; F16M 13/022

(57) ABSTRACT

There is provided a holding member including a coupling part configured to be coupled with a small imaging device, and a handle configured to be gripped by a user.

### CROSS REFERENCE TO RELATED APPLICATIONS

This application is a U.S. National Phase of International Patent Application No. PCT/JP2015/001452 filed on Mar. 16, 2015, which claims priority benefit of Japanese Patent Application No. JP 2014-102228 filed in the Japan Patent Office on May 16, 2014, and also claims priority benefit of Japanese Patent Application No. JP 2014-116595 filed in the Japan Patent Office on Jun. 5, 2014. Each of the above-referenced applications is hereby incorporated herein by reference in its entirety.

### TECHNICAL FIELD

The present disclosure relates to a holding member and an imaging unit.

### BACKGROUND ART

In the related art, small imaging devices such as a compact digital still camera and a compact video camera are known. For example, as one mode of the small imaging device, a digital still camera having a cylindrical shape has been put to practical use, recently.

### CITATION LIST

### Patent Literature

### [PTL 1]

### Japanese Utility Model Registration No. 3190001

### SUMMARY

### Technical Problem

However, sometimes it is difficult to hold such small imaging device in a normal photographing mode for photographing surrounding scenery or the like, or in a self-portrait photographing mode.

Therefore, according to embodiments of the present disclosure, there is provided a holding member to be used by being attached to a small imaging device in a manner that a user can easily hold the small imaging device, and an imaging unit including the holding member.

### Solution to Problem

According to an embodiment of the present disclosure, there is provided a holding member including a coupling part configured to be coupled with a small imaging device, and a handle configured to be gripped by a user.

According to another embodiment of the present disclosure, there is provided an imaging unit including a small imaging device, and a holding member including a coupling part coupled with the small imaging device, and a handle to be gripped by a user.

### Advantageous Effects of Invention

As described above, according to one or more embodiments of the present disclosure, the user can easily hold the small imaging device.

Note that the present disclosure is not limited to the effect stated above and in addition to or in place of the effect stated above, may achieve any of the effects indicated in this specification or effects that can be understood from the specification.

### BRIEF DESCRIPTION OF DRAWINGS

FIG. 1 is a perspective view showing a holding member according to a first embodiment of the present disclosure.

FIG. 2 is a side view of the holding member in FIG. 1 when viewed from a direction of arrow D1.

FIG. 3 is a side view of the holding member in FIG. 1 when viewed from a direction of arrow D2.

FIG. 4 is a side view of the holding member in FIG. 1 when viewed from a direction of arrow D3.

FIG. 5 is a side view of the holding member in FIG. 1 when viewed from a direction of arrow D4.

FIG. 6 is a diagram of the holding member according to the embodiment when viewed from a flange side.

FIG. 7 is a diagram of the holding member according to the embodiment when viewed from a coupling part side.

FIG. 8 is a cross-sectional view of the holding member according to the embodiment.

FIG. 9 is an explanatory diagram showing a holding example when an imaging unit according to the embodiment photographs surroundings.

FIG. 10 is an explanatory diagram showing a holding example when the imaging unit according to the embodiment photographs a self-portrait.

FIG. 11 is an explanatory diagram showing another holding example when the imaging unit according to the embodiment photographs a self-portrait.

FIG. 12 is an explanatory diagram showing another holding example when the imaging unit according to the embodiment photographs a self-portrait.

FIG. 13 is an explanatory diagram showing a holding example when the imaging unit according to the embodiment is carried.

FIG. 14 is a perspective view showing a holding member according to a second embodiment of the present disclosure.

FIG. 15 is an explanatory diagram showing a holding example when an imaging unit according to the embodiment photographs surroundings.

FIG. 16 is a perspective view showing a holding member according to a modification of the embodiment.

FIG. 17 is an explanatory diagram showing a holding example when the imaging unit according to the modification of the embodiment photographs a self-portrait.

FIG. 18 is an explanatory diagram showing a usage example of the imaging unit according to the modification of the embodiment.

FIG. 19 is a perspective view showing a holding member according to a third embodiment of the present disclosure.

FIG. 20 is an explanatory diagram showing a holding example when the imaging unit according to the embodiment photographs a self-portrait.

FIG. 21 is a perspective view showing a holding member according to a modification of the embodiment.

FIG. 22 is an explanatory diagram showing a holding example when an imaging unit according to the modification of the embodiment photographs a self-portrait.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description is given in the following order.

### 1. First Embodiment

### 1.1. Configuration Example of Holding Member

### 1.2. Example of Holding Small Imaging Device

### 2. Second Embodiment

### 2.1. Configuration Example of Holding Member

### 2.2. Example of Holding Small Imaging Device

### 2.3. Modification of Holding Member

### 3. Third Embodiment

### 3.1. Configuration Example of Holding Member

### 3.2. Example of Holding Small Imaging Device

### 3.3. Modification of Holding Member

### 1. First Embodiment

### (1.1. Configuration Example of Holding Member)

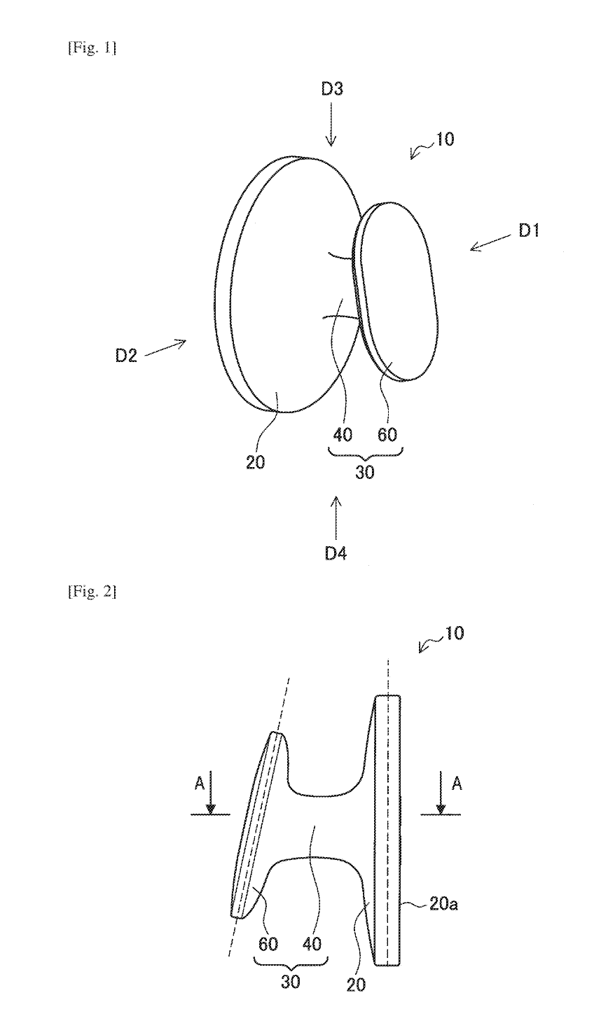

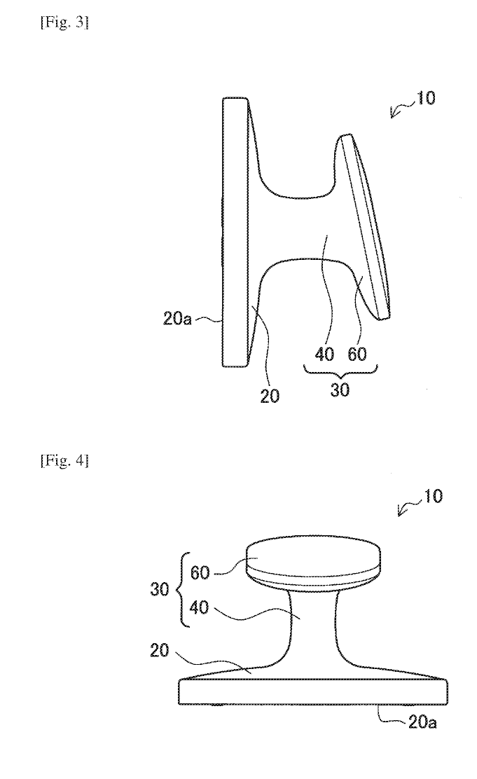

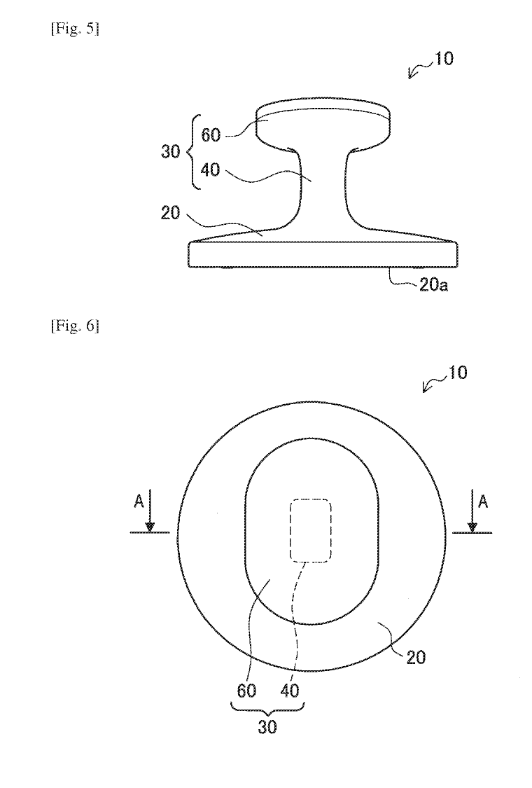

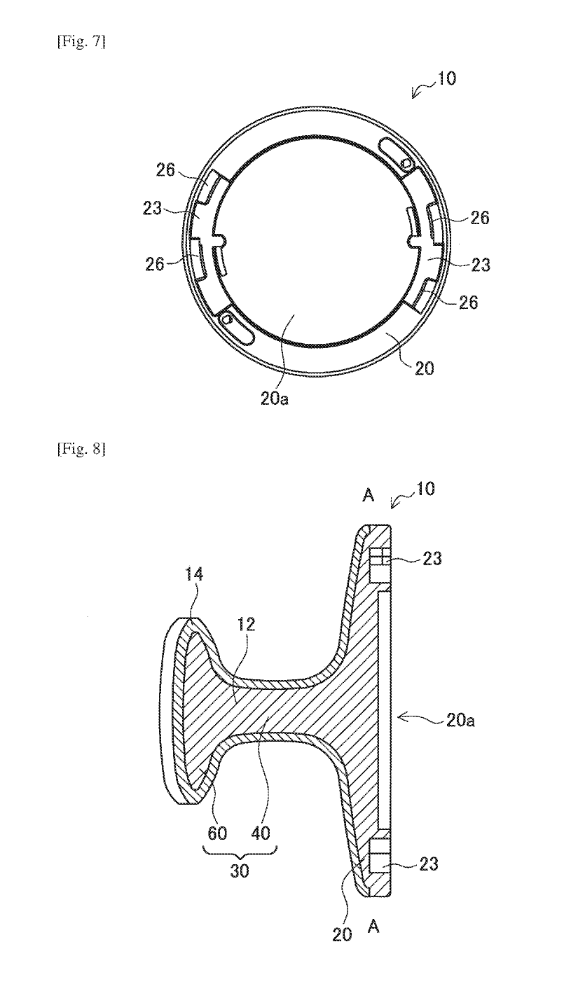

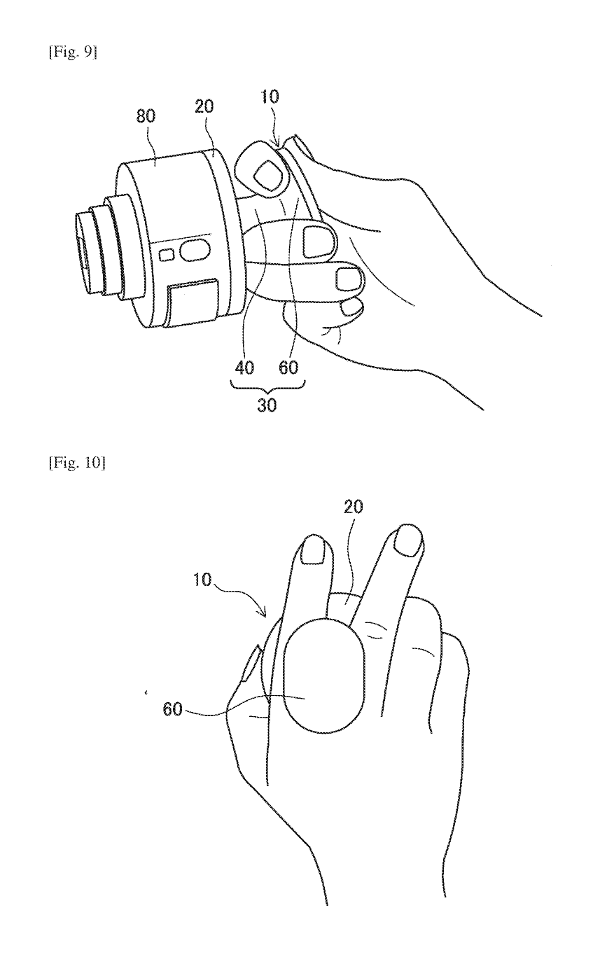

First, with reference to FIGS. 1 to 8, a schematic configuration of a holding member 10 according to a first embodiment of the present disclosure is explained. FIG. 1 is a perspective view showing the holding member 10 according to the present embodiment. FIGS. 2 to 5 are side views of the holding member 10 when viewed from directions of arrows D1 to D4 in FIG. 1, respectively. FIGS. 6 and 7 are diagrams of the holding member 10 when viewed from a flange 60 side and a coupling part 20 side, respectively. FIG. 8 is a cross-sectional view of A-A cross-section in FIGS. 2 and 6 when viewed from a direction of arrows.

The holding member 10 according to the present embodiment is an attachment to be used by being attached to a so-called small digital still camera (hereinafter, also referred to as “lens-style camera”) having a lens barrel shape, as one mode of the small imaging device. The entire lens-style camera has a cylindrical outer shape, and it is difficult to hold the lens-style camera during photographing in a manner that a lens faces a predetermined direction when only the lens-style camera is used. Moreover, when only the lens-style camera is used, it is difficult to recognize an attitude in a horizontal direction or in a vertical direction. The holding member 10 is attached to such lens-style camera in a manner that the lens-style camera is easily held.

The holding member 10 includes the coupling part 20 and the handle 30. The holding member 10 is configured as a formed body in which a rubber part 14 formed of soft material such as synthetic rubber covers a hard part 12 formed of hard thermoplastic resin or the like, the hard part 12 forming a skeleton. Meanwhile, an end surface 20a on the coupling part 20 side facing the lens-style camera is not covered by the rubber part 14, and the hard part 12 is exposed. Accordingly, the holding member is tightly fixed on the lens-style camera, and durability can be improved.

On the other hand, the relatively soft rubber part 14 covers a portion other than the end surface 20a to abut on the lens-style camera. The rubber part 14 fits comfortably in the user's hand, and also provides non-slip effect. For example, the hard part 12 and the rubber part 14 are integrated by insert molding, and thereby the holding member 10 can be manufactured. The holding member 10 having such two-layer structure is composed of only a single component that does not includes a coupling portion such as a screw. Accordingly, the holding member 10 contributes to reduction in production cost. In the holding member 10 according to the present embodiment, the rubber part 14 covers the entire portion other than the end surface 20a. However, the rubber part 14 may be only at least a part of a portion to be in contact with the user's hand.

The coupling part 20 is formed to have a flat outer shape that is similar to an outer shape of a surface of the lens-style camera to which the holding member 10 is attached. In the holding member 10 according to the present embodiment, the coupling part 20 has the circular outer shape that is substantially identical to the outer shape of the surface of the lens-style camera to which the holding member 10 is attached. Accordingly, a feeling of strangeness in appearance is not given when the holding member 10 is attached to the lens-style camera. At a periphery of the end surface 20a on an opposite side of a side where the handle 30 is formed, the coupling part 20 has a groove 23 into which an engagement claw provided on the lens-style camera is inserted. In the groove 23, an engagement claw 26 to fit the engagement claw of the lens-style camera is provided. Accordingly, the holding member 10 is fixed on the lens-style camera by a bayonet mechanism in which the engagement claw 26 formed in the groove 23 of the coupling part 20 fits the engagement claw of the lens-style camera.

In the holding member 10 according to the present embodiment, the handle 30 to be gripped by the user includes a pillar 40 and a flange 60. In a state in which the holding member 10 is attached to the lens-style camera, the user can easily hold the lens-style camera by gripping at least one of the pillar 40 and the flange 60.

The pillar 40 protrudes from a central part on an opposite side of the end surface 20a side of the flat coupling part 20. The pillar 40 may be a portion to be gripped by the user's fingers. A cross-sectional shape of the pillar 40 is substantially rectangular in a direction intersecting a direction in which the pillar 40 extends. Since the cross-sectional shape of the pillar 40 is a substantially rectangular shape that has a longitudinal direction, the user can haptically recognize an attitude of the holding member 10 when gripping the pillar 40.

According to the present embodiment, the longitudinal direction of the cross-sectional shape of the pillar 40 is identical to a top-bottom direction of the lens-style camera, in a state in which the holding member 10 is attached to the lens-style camera. Note that, in the present specification, the top-bottom direction of the lens-style camera means a direction corresponding to a top-bottom direction defined in information on an image photographed by the lens-style camera. Accordingly, the user can haptically recognize the attitude of the holding member 10 via the pillar 40 and can hold the lens-style camera in a horizontal direction or in a vertical direction, easily. Length of a long side and a short side of the cross-sectional shape of the pillar 40 and length (height) of the pillar 40 are appropriately set in a manner that the user can easily grip the pillar 40.

The flange 60 is formed to have a flat and oval outer shape, and a central part of the flange 60 connects to the pillar 40. The flange 60 continues into the pillar 40 on the opposite side of the coupling part 20. The flange 60 may be a portion to be gripped by the user's fingers. Since the outer shape of the flange 60 is an oval shape that has a longitudinal direction, the user can haptically recognize an attitude of the holding member 10 when gripping the flange 60. In addition, the user can visually recognize the attitude of the holding member by having visual contact with the flange 60.

In the present embodiment, the longitudinal direction of the oval flange 60 is identical to a direction of the long side of the cross-sectional shape of the pillar 40. In other words, the longitudinal direction of the flange 60 is identical to the top-bottom direction of the lens-style camera, in the state in which the holding member 10 is attached to the lens-style camera. Accordingly, the user can haptically or visually recognize the attitude of the holding member via the flange 60 and can hold the lens-style camera in the horizontal direction or in the vertical direction, easily. In addition, since the flange 60 has the oval shape, the flange overhangs less in one direction. Accordingly, an index finger and a middle finger can be easily inserted in and out by spreading the two fingers a bit when the pillar 40 is sandwiched between the two fingers. Thickness of the flange 60 and length of the outer shape of the flange 60 in the longitudinal direction and in a direction perpendicular to the longitudinal direction are appropriately set in a manner that the user can easily grip the flange 60 or in a manner that the fingers can be easily inserted in and out.

In addition, since the flat flange 60 continues into the relatively thin pillar 40, the flange 60 also has a function of supporting the fingers when the user grips the pillar 40 with the fingers. Accordingly, since the flange 60 is provided together with the pillar 40, the hand and the fingers of the user can be supported at a plurality of points. That is, stability can be improved when the lens-style camera is held via the holding member 10. In addition, since the holding member 10 includes the flat coupling part 20 and the flat flange 60 that continue via the relatively thin pillar 40, diverse ways to hold are possible. Accordingly, usefulness of the lens-style camera can be improved.

As shown in FIG. 2, in the holding member 10 according to the present embodiment, the flat coupling part 20 and the flat flange 60 are not parallel when viewed from a lateral side in a direction in which the pillar 40 extends. According to the present embodiment, a space between the coupling part 20 and the flange 60 spreads gradually toward a lower side in the top-bottom direction of the lens-style camera, in the state in which the holding member 10 is attached to the lens-style camera. Note that, the direction in which the space between the coupling part 20 and the flange 60 spreads is not limited to the downward direction. For example, an upward direction or a right-left (lateral) direction is possible.

With regard to the holding member 10 according to the present embodiment, the user can haptically recognize the attitude of the holding member 10 also by the configuration in which the coupling part 20 and the flange 60 are not parallel, and can easily hold the lens-style camera in the horizontal direction or in the vertical direction. According to the configuration, fingers can be inserted into the space between the coupling part 20 and the flange 60 from a direction in which the space spreads, regardless of sizes of fingers. Also according to the configuration, fingers inserted into the space between the coupling part 20 and the flange 60 abut on and are supported by the coupling part 20 and the flange 60 in a portion where the space is narrowed. Moreover, according to the configuration, the shape of the holding member 10 suits the shape of the fingers and the hand, and a large area of the fingers and the hand can support the holding member 10. That is, the holding member 10 according to the present embodiment is compatible with various sizes of fingers, and can be easily gripped. Accordingly, stability can be improved when the lens-style camera is held.

As shown in FIG. 2, a portion connecting the coupling part 20 and the pillar 40, a portion connecting the pillar 40 and the flange 60, and respective surfaces of the coupling part 20, the pillar 40, and the flange 60 are formed by curved surfaces. That is, the holding member 10 fits comfortably in the user's hand when the user holds the holding member 10, and the lens-style camera can be held stably.

As explained above, in the holding member 10 according to the present embodiment, a cross-sectional shape and an outer shape of the pillar 40 and the flange 60 that compose the handle 30 are rectangular or oval. Accordingly, the user can haptically or visually recognize the attitude of the holding member 10. In addition, with regard to the holding member 10, the user can haptically recognize the attitude of the holding member 10 also by the configuration in which the coupling part 20 and the flange 60 are not parallel. At this time, a direction in which the holding member 10 is attached to the lens-style camera may be one direction, or a top-bottom direction or a right-left direction may be selected. Freedom of how to hold the holding member 10 or the lens-style camera can be enhanced in a case in which the top-bottom direction and the right-left direction can be selected when the holding member 10 is attached to the lens-style camera.

### (1.2. Example of Holding Small Imaging Device)

Next, an example of holding a small imaging device to which the holding member 10 according to the present embodiment is attached is explained. With reference to FIGS. 9 to 13, an imaging unit in which the holding member 10 is attached to a lens-style camera 80 is held.

For example, FIG. 9 shows an example of holding the lens-style camera 80 when surrounding scenery or the like is photographed. In the example shown in FIG. 9, the user inserts the index finger and the middle finger into the space between the coupling part 20 and the flange 60 from a lateral direction in a manner that the pillar 40 is sandwiched. In addition, the thumb presses the flange 60, and the flange 60 is gripped by the thumb, the index finger, and the middle finger. In this case, the hand or the fingers of the user are supported by the holding member 10 at a plurality of points, and the user can hold the lens-style camera 80 stably. At this time, since the user visually recognize the flange 60 having the oval outer shape, the user can use the lens-style camera 80 while visually recognizing the horizontal direction or the vertical direction of the lens-style camera 80.

In addition, in the example shown in FIG. 9, since the user touches the oval flange 60, the user can use the lens-style camera 80 while haptically recognizing the horizontal direction or the vertical direction of the lens-style camera 80. At the same time, the user can use the lens-style camera 80 while recognizing the horizontal direction or the vertical direction of the lens-style camera 80 also by touching an upper surface and a lower surface of the pillar 40 having the rectangular cross-sectional shape, for example.

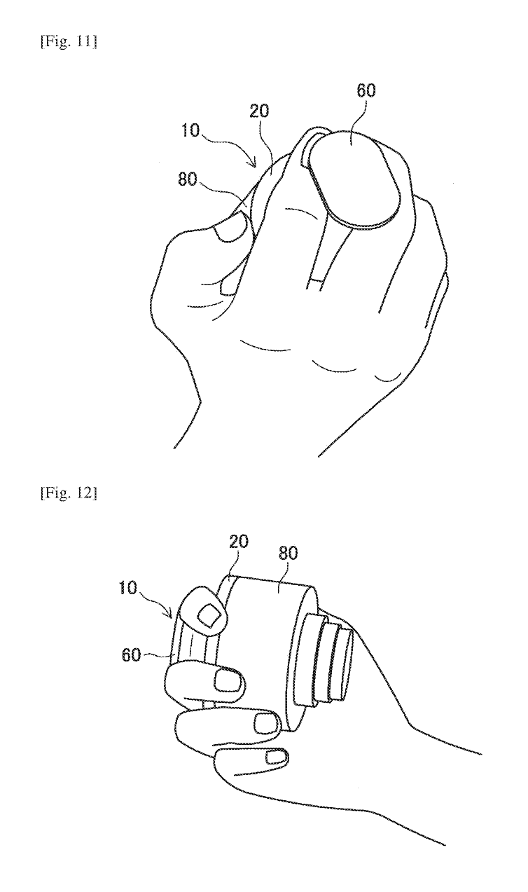

FIGS. 10 to 12 each show an example of holding the lens-style camera 80 when a self-portrait is photographed. In the example shown in FIGS. 10 and 11, the user inserts the index finger and the middle finger into the space between the coupling part 20 and the flange 60 from a lower side in a manner that the pillar 40 is sandwiched. Accordingly, the lens-style camera is held with the plurality of fingers and the palm. An insertion degree of the fingers into the space between the coupling part 20 and the flange 60 is different between FIGS. 10 and 11. In the example in FIG. 10, the fingers are inserted deeper than that of the example in FIG. 11. Alternatively, in the example shown in FIG. 12, the user inserts the index finger and the middle finger into the space between the coupling part 20 and the flange 60 from a lateral direction in a manner that the pillar 40 is sandwiched. Accordingly, the lens-style camera is held with the plurality of fingers and the palm.

In such holding examples, the hand or the fingers of the user are supported by the holding member 10 at a plurality of points, and the user holds the lens-style camera with the entire hand. Accordingly, the user can hold the lens-style camera stably. In addition, the user can use the lens-style camera while haptically recognizing the horizontal direction or the vertical direction of the lens-style camera by touching the both side surface of the pillar 40 having the rectangular cross-sectional shape, for example.

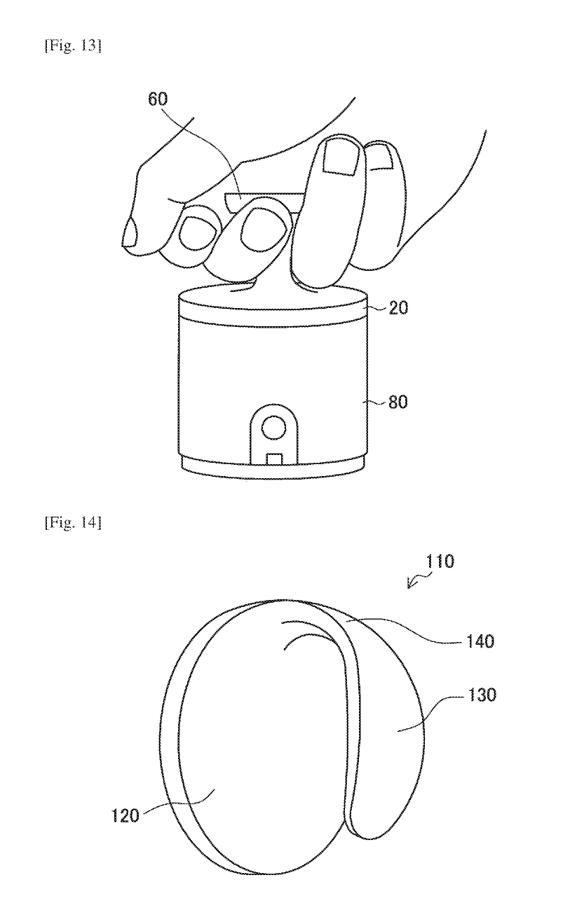

FIG. 13 shows an example of holding the lens-style camera 80 when the lens-style camera 80 is carried. In the example shown in FIG. 13, the user inserts the middle finger and the ring finger into the space between the coupling part 20 and the flange 60 in a manner that the pillar 40 is sandwiched. Accordingly, the lens-style camera 80 is held in a manner that the flange 60 is seized by the fingers and the palm. As explained above, since the holding member 10 is attached to the lens-style camera 80, a portion on which the user's finger can be hooked is created, and the lens-style camera 80 can be stably held. Accordingly, it becomes easy to carry the lens-style camera 80, and the risk of falling can be reduced.

As explained above, since the holding member 10 according to the present embodiment includes the handle 30 having the pillar 40 and the flange 60, the hand or the fingers of the user can be supported at the plurality of points. That is, the lens-style camera 80 to which the holding member 10 is attached can be held stably. In addition, in the holding member 10 according to the present embodiment, the cross-sectional shape of the pillar 40 is substantially rectangle, and the outer shape of the flange 60 is oval. Accordingly, the user can haptically or visually recognize the attitude of the holding member 10, and the user can hold the lens-style camera 80 while recognizing the horizontal direction or the vertical direction.

### 2. Second Embodiment

### (2.1. Configuration Example of Holding Member)

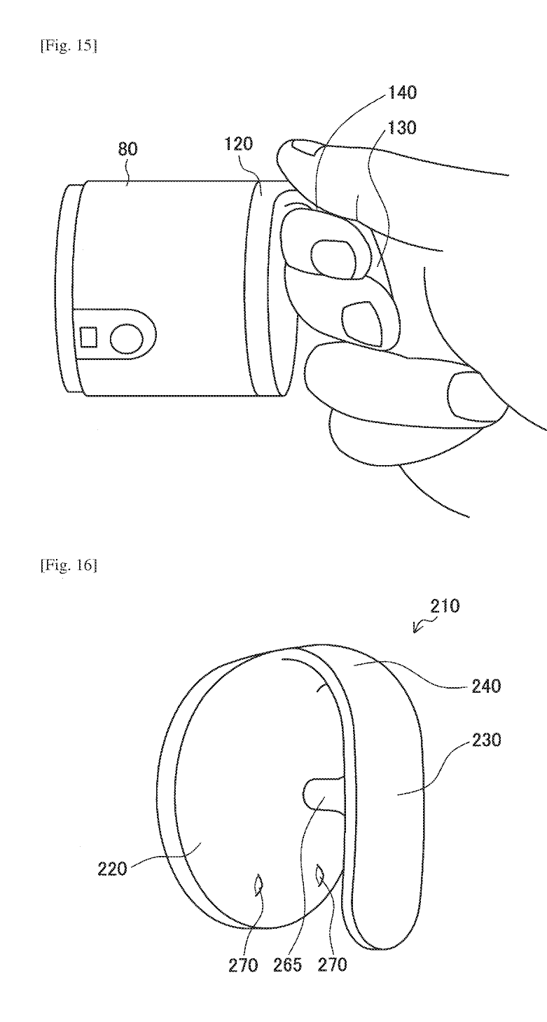

Next, a configuration example of a holding member according to a second embodiment of the present disclosure is explained. FIG. 14 is a perspective view of a holding member 110 according to the present embodiment. The holding member 110 according to the present embodiment is also used by being attached to the lens-style camera. A form of a handle 130 of the holding member 110 is different from that of the holding member 10 according to the first embodiment, but other basic configuration is common to that of the holding member 10. The handle 130 of the holding member 110 according to the present embodiment has a substantially oval outer shape having a longitudinal direction, and is connected to a coupling part 120 via a bent part 140 that continues from one end side in the longitudinal direction. The handle 130 has a curved shape that protrudes to an opposite side of the coupling part 120 side. The fingers seize the handle 130, and the holding member 110 is easily gripped.

In the holding member 110 according to the present embodiment, the handle 130 is connected to an edge of the coupling part 120 at an upper side in the top-bottom direction of the lens-style camera, in a state in which the holding member 110 is attached to the lens-style camera. That is, the longitudinal direction of the handle 130 matches the top-bottom direction of the lens-style camera. Accordingly, by the bent part 140 or the handle 130 having the longitudinal direction, the user can haptically or visually recognize the attitude of the holding member 110, and can recognize the horizontal direction or the vertical direction of the lens-style camera.

Also in the holding member 110 according to the present embodiment, a portion connecting the coupling part 120 and the handle 130, and respective surfaces of the coupling part 120 and the handle 130 are formed by curved surfaces. That is, the holding member 110 fits comfortably in the user's hand when the user holds the holding member 110, and the lens-style camera can be held stably. Structure other than the structure described above is the same as that of the holding member 10 according to the first embodiment.

### (2.2. Example of Holding Small Imaging Device)

Next, an example of holding a small imaging device to which the holding member 110 according to the present embodiment is attached is explained. With reference to FIG. 15, an imaging unit in which the holding member 110 is attached to a lens-style camera 80 is held.

FIG. 15 shows an example of holding the lens-style camera 80 when surrounding scenery or the like is photographed. In the example shown in FIG. 15, the user inserts the index finger and the middle finger into the space between the coupling part 120 and the handle 130, and the handle 130 is gripped by the fingers, and the bent part 140 is sandwiched between the thumb and the index finger. In this case, the user's fingers are supported by the holding member 110 at a plurality of points, and the user can hold the lens-style camera 80 stably. At this time, since the user visually recognize the handle 130 that has the longitudinal direction, the user can use the lens-style camera 80 while visually recognizing the horizontal direction or the vertical direction of the lens-style camera 80.

In addition, the user can use the lens-style camera 80 while visually recognizing the horizontal direction or the vertical direction of the lens-style camera 80 also by sandwiching the bent part 140 positioned at the upper side in the top-bottom direction of the lens-style camera 80. Moreover, since the user touches the handle 130 that has the longitudinal direction, the user can use the lens-style camera 80 while haptically recognizing the horizontal direction or the vertical direction of the lens-style camera 80.

Although it is not illustrated in the drawings, the user can insert the index finger and the middle finger into the space between the coupling part 130 and the handle 130, and can hold the lens-style camera 80 with the entire hand when a self-portrait is photographed by the lens-style camera 80 to which the holding member 110 according to the present embodiment is attached. At this time, the bent part 140 is held in a manner that the index finger hooks on the handle 130. Accordingly, the lens-style camera 80 can be stably held. In addition, since the bent part 140 positioned at the upper side in the top-bottom direction of the lens-style camera 80 can be supported by the index finger, the user can use the lens-style camera 80 while haptically recognizing the horizontal direction or the vertical direction of the lens-style camera 80.

As explained above, since the holding member 110 according to the present embodiment includes the handle 130 that has the bent part 140 and whose one end is connected to the coupling part 120, the hand or the fingers of the user can be supported at the plurality of points. That is, the lens-style camera 80 to which the holding member 110 is attached can be held stably. In addition, in the holding member 110 according to the present embodiment, the handle 130 is connected to an edge of the coupling part 120 at the upper side in the top-bottom direction of the lens-style camera 80, and the handle 130 has the oval outer shape. Accordingly, the user can haptically or visually recognize the attitude of the holding member 110, and the user can hold the lens-style camera 80 while recognizing the horizontal direction or the vertical direction.

### (2.3. Modification of Holding Member)

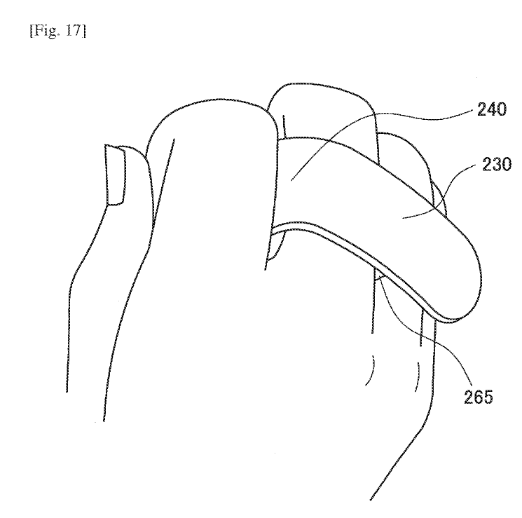

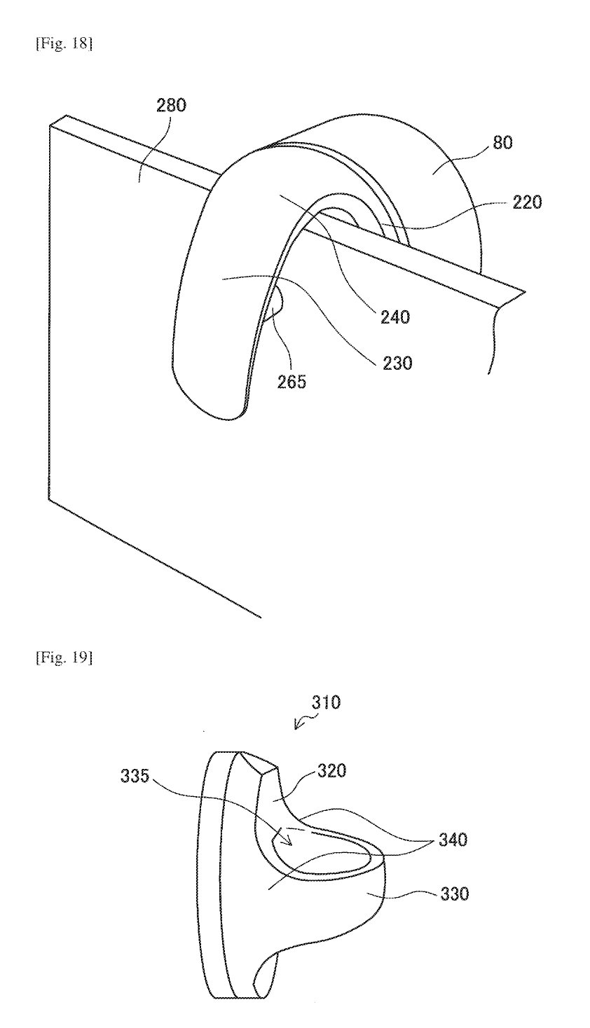

Next, with reference to FIGS. 16 to 18, a holding member 210 according to a modification of the second embodiment is explained. FIG. 16 is a perspective view of a holding member 210 according to the present modification. FIGS. 17 and 18 are each a usage example of the holding member 210. A coupling part 220 and a handle 230 that compose the holding member 210 is basically the same as those of the holding member 110.

As shown in FIG. 16, the handle 230 of the holding member 210 according to the modification has a rectangular outer shape that has rounded corners and that has a longitudinal direction, and the handle 230 is connected to a coupling part 220 via a bent part 240 that continues from one end side in the longitudinal direction. A protrusion 265 is provided on a central part of a surface of the handle 230 in the longitudinal direction, the surface facing the coupling part 220. When the user holds the holding member 210, the protrusion 265 becomes a portion to be sandwiched between fingers, and functions to increase supports of the fingers. Alternatively, when the lens-style camera is held by a housing of a laptop personal computer, a wall or the like by using the space between the coupling part 220 and the handle 230, the protrusion 265 functions to press the housing, the wall or the like from the back.

An outer shape of the protrusion 265 is substantially rectangular and has a longitudinal direction intersecting the longitudinal direction of the handle 230. The longitudinal direction of the outer shape of the protrusion 265 is identical to a lateral direction against the top-bottom direction of the lens-style camera, in the state in which the holding member 210 is attached to the lens-style camera. Thickness of the protrusion 265, in other words, width in a direction along the longitudinal direction of the handle 230 has appropriate thickness so as to be easily sandwiched between two fingers. In addition, height of the protrusion 265, in other words, protrusion width from the handle 230 toward the coupling part 230 side has appropriate length in view of the wall or the like inserted into a space between a tip of the protrusion 265 and the coupling part 220. Moreover, respective corners of the protrusion 265 having a cuboid shape, and a portion connecting the protrusion 265 and the handle 230 are formed by curved surfaces. Accordingly, the protrusion 265 fits comfortably in the hand.

In a way similar to the holding member according to the first embodiment, in the coupling part 220 of the holding member 210, a central portion of a surface 220a facing the handle 230 has a curved convex surface. According to the curved surface, the holding member 210 fits comfortably in the hand of the user who holds the holding member 210. In addition, the holding member 210 has two projections 270 on the surface 220a of the coupling part 220. The two projections 270 are symmetrically provided on a lower side in a state in which the position where the coupling part 220 connects to the handle 230 is set as a top. When the lens-style camera is held by the wall or the like by using the space between the coupling part 220 and the handle 230, the two projections 270 are in contact with the wall or the like, and the lens-style camera can be supported by the projections 270 even if the coupling part 220 has the rounded surface 220a. Accordingly, stability of holding can be improved.

FIG. 17 shows an example of holding the lens-style camera when a self-portrait is photographed. In the example shown in FIG. 17, the user inserts the middle finger and the ring finger into the space between the coupling part 220 and the handle 230, and the lens-style camera is held with the plurality of fingers and the palm. The protrusion 265 is sandwiched between the middle finger and the ring finger. In this case, the user's fingers are supported by the holding member 210 at a plurality of points, and the user can hold the lens-style camera 80 stably. In addition, since the surface 220a of the coupling part 220 with which the user's palm is in contact has the convex curved surface, the surface 220a fits comfortably in the user's hand.

At this time, since the bent part 240 positioned at the upper side in the top-bottom direction of the lens-style camera is supported by the middle finger, the user can use the lens-style camera while haptically recognizing the horizontal direction or the vertical direction of the lens-style camera. In addition, the user can use the lens-style camera while haptically recognizing the horizontal direction or the vertical direction of the lens-style camera also by the protrusion 265 that has the longitudinal direction identical to the lateral direction against the top-bottom direction of the lens-style camera.

With reference to the usage example in FIG. 18, the lens-style camera 80 to which the holding member 210 is attached is held by a housing 280 of a laptop personal computer. For example, the housing 280 contains a display. In the example in FIG. 18, the handle 230 of the holding member 210 is hooked on the housing 280. At this time, the housing 280 is supported by the coupling part 220 and the bent part 240 of the holding member 210, and also is supported by the protrusion 265.

Although it is not illustrated in the drawings, two projections 270 provided on the surface 220a of the coupling part 220 abut on the housing 280. The housing 280 is also supported by the projections 270. That is, the lens-style camera 80 can be held stably. In addition, the handle 230 is connected to an edge of the coupling part 220 at the upper side in the top-bottom direction of the lens-style camera 80, and is held while the top-bottom direction of the lens-style camera 80 matches the vertical direction.

### 3. Third Embodiment

### (3.1. Configuration Example of Holding Member)

Next, a configuration example of a holding member according to a third embodiment of the present disclosure is explained. FIG. 19 is a perspective view of a holding member 310 according to the present embodiment. The holding member 310 according to the present embodiment is also used by being attached to the lens-style camera. A form of a handle 330 is different from those of the holding members according to the first and second embodiments, but other basic configuration is common to those of the holding members.

An outer shape of the handle 330 of the holding member 310 according to the present embodiment is a substantially ring shape with an opening 335. When the holding member 310 is viewed from the handle 330 side, the handle 330 has a longitudinal direction. The opening 335 is a region into which the user's finger or the like is inserted. Two bases 340 are portions connecting the handle 330 and the coupling part 320, and are erected from both edges in a radial direction of the coupling part 320. The handle 330 and a part of the coupling part 320 are integrally formed into the ring shape. The opening 335 of the handle 330 is formed into a circular shape, and fits comfortably in a shape of a finger.

According to the present embodiment, the two bases 340 are positioned at the both edge in the lateral direction against the top-bottom direction of the lens-style camera, in a state in which the holding member 310 is attached to the lens-style camera. That is, the handle 330 having the substantially ring shape is disposed on a virtual plane perpendicular to the top-bottom direction of the lens-style camera. In other words, a direction of a finger inserted into the opening 335 matches the top-bottom direction of the lens-style camera. Accordingly, by the two bases 340 or the handle 330, the user can haptically or visually recognize an attitude of the holding member 310, and can recognize the horizontal direction or the vertical direction of the lens-style camera.

Thickness of the handle 330 can be appropriately set in view of strength, ease of grip by the user, or the like. In addition, a size of the opening 335 can also be appropriately set in view of ease of insertion of the finger by the user, or a supporting state while the finger is inserted. Structure other than the structure described above is the same as that of the holding member 10 according to the first embodiment.

### (3.2. Example of Holding Small Imaging Device)

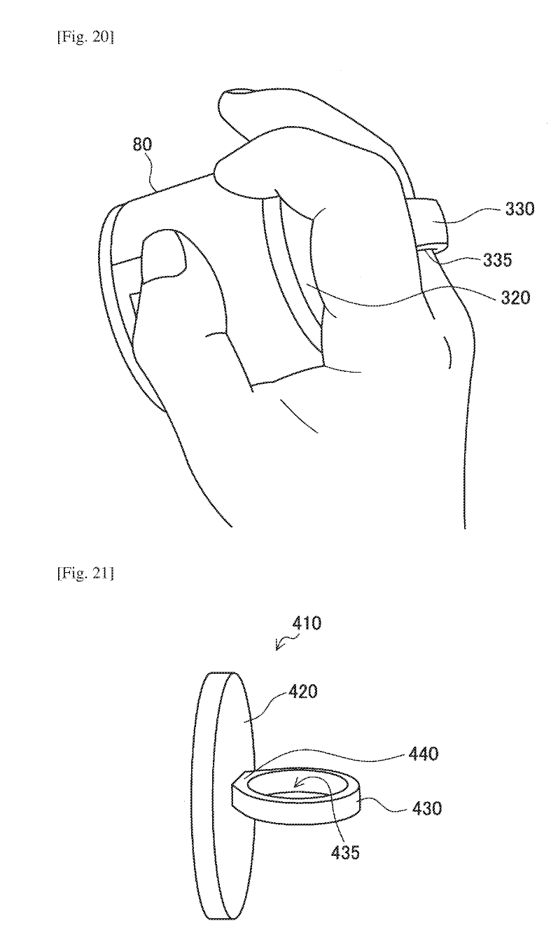

Next, an example of holding a small imaging device to which the holding member 310 according to the present embodiment is attached is explained. With reference to FIG. 20, an imaging unit in which the holding member 310 is attached to a lens-style camera 80 is held.

FIG. 20 shows an example of holding the lens-style camera 80 when a self-portrait is photographed. In the example shown in FIG. 20, the user inserts the middle finger into the opening 335, and the lens-style camera 80 is held with the entire hand. The middle finger is deeply inserted into the opening 335. In this case, the middle finger is supported by the holding member 310 at a plurality of points, and the user can hold the lens-style camera 80 stably. At this time, the user inserts the finger into the opening 335 along the top-bottom direction of the lens-style camera 80, and touches the handle 330 and the two bases 340 at the both ends of the handle 330. Accordingly, the user can use the lens-style camera 80 while haptically recognizing the horizontal direction or the vertical direction of the lens-style camera 80.

As explained above, the holding member 310 according to the present embodiment has the opening 335 in the ring-shaped handle 330 connected via the bases 340 at the both end sides in the radial direction of the coupling part 320. That is, the finger inserted into the opening 335 can be supported by the surrounding handle 330 at a plurality of points, and the lens-style camera 80 to which the holding member 310 is attached can be held stably. In addition, in the holding member 310 according to the present embodiment, the handle 330 is disposed on the virtual plane perpendicular to the top-bottom direction of the lens-style camera 80, and the user inserts the finger into the opening 335 along the top-bottom direction of the lens-style camera 80. Accordingly, the user can haptically or visually recognize the attitude of the holding member 310, and the user can hold the lens-style camera 80 while recognizing the horizontal direction or the vertical direction.

### (3.3. Modification of Holding Member)

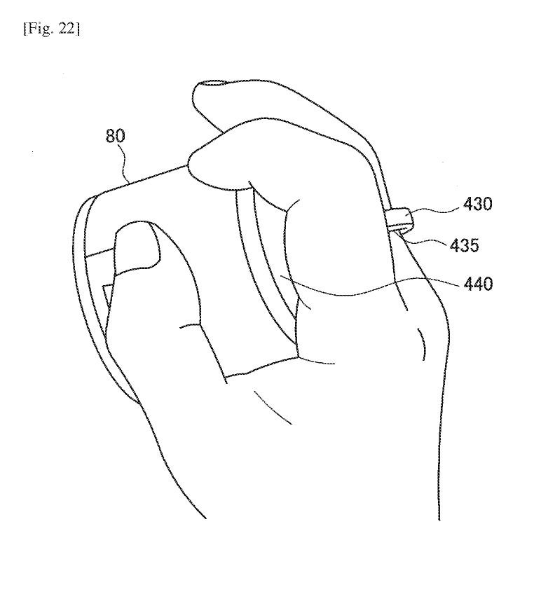

Next, with reference to FIGS. 21 and 22, a holding member 410 according to a modification of the third embodiment is explained. FIG. 21 is a perspective view of a holding member 410 according to the present modification. FIG. 22 is a usage example of the holding member 410. A coupling part 420 that composes the holding member 410 is basically the same as that of the holding member 10 according to the first embodiment.

As shown in FIG. 21, an outer shape of the handle 430 of the holding member 410 according to the modification is a ring shape, and the handle 430 is connected to a base 440 protruding from the central part of the coupling part 420. When the holding member 410 viewed from the handle 430 side, the handle 430 has a longitudinal direction. In the holding member 310, the ring-shaped handle 330 is connected to the two bases 340 erected from the both ends in the radial direction of the coupling part 320. On the other hand, in the holding member 410 according to the modification, the ring-shaped handle 430 is connected to the base 440 erected from the central part of the coupling part 420. The ring-shaped handle 430 of the holding member 410 is also disposed on the virtual plane perpendicular to the top-bottom direction of the lens-style camera, in a state in which the holding member 410 is attached to the lens-style camera. That is, the user inserts the finger into the opening 435 of the ring-shaped handle 430 along the top-bottom direction of the lens-style camera.

FIG. 22 shows an example of holding the lens-style camera 80 when a self-portrait is photographed. Also in the example shown in FIG. 22, the user inserts the middle finger into the opening 435 of the ring-shaped handle 430, and the lens-style camera 80 is held with the entire hand. The middle finger is deeply inserted into the opening 435. In the modification, the middle finger is supported by the holding member 410 at a plurality of points, and the user can hold the lens-style camera 80 stably. At this time, the user inserts the finger into the opening 435 along the top-bottom direction of the lens-style camera 80, and touches the handle 430. Accordingly, the user can use the lens-style camera 80 while haptically recognizing the horizontal direction or the vertical direction of the lens-style camera 80.

Note that, in the holding members 310 and 410 according to the third embodiment, the user inserts the finger into the openings 335 and 435 along the top-bottom direction of the lens-style camera. However, the direction in which the finger is inserted is not limited to such examples. For example, the ring-shaped handles 330 and 430 may be disposed on the virtual planes along the top-bottom direction of the lens-style camera, and the finger may be inserted in the lateral direction. Also according to such configuration, the user's finger can be supported by the holding member at the plurality of points, and the user can use the lens-style camera while haptically or visually recognizing the horizontal direction or the vertical direction of the lens-style camera.

Hereinabove, although the exemplary embodiment of the present disclosure has been described in detail with reference to the accompanying drawings, the technical scope of the present disclosure is not limited thereto. It should be understood by those skilled in the art that various modifications, combinations, sub-combinations and alterations may occur depending on design requirements and other factors insofar as they are within the scope of the appended claims or the equivalents thereof.

For example, in the above embodiments, the lens-style camera is used as an example of the small imaging device. However, the present technology is not limited thereto. The holding members can be applied to various small cameras such as a small digital still camera and a small video camera.

In addition, in the above embodiments, the rectangular shape, the oval shape, the reed shape, and the ring shape are used as examples of the form for recognizing the attitudes of the holding members. However, the present technology is not limited thereto, and may include various other shapes.

In addition, in the above embodiments, the coupling part and the handle are integrated and the holding member is formed. However, the present technology is not limited thereto. For example, an angle between the coupling part and the handle, or an angle between the pillar and the flange may be variable by using an arm joint or a ball joint. In the case where the angles are variable, the present technology can adjust to a various size of hands and fingers of users, and diverse ways to hold.

Furthermore, the advantages discussed in this specification are only intended for illustrative and exemplary purposes and are not limitative. In other words, in addition to or in place of the above-described advantages, the technology according to the embodiments of the present disclosure may exhibit other advantages that are obvious to a skilled person from the specification.

Additionally, the present technology may also be configured as below.

(1)
A holding member including:
a coupling part configured to be coupled with a small imaging device; and
a handle configured to be gripped by a user.
(2)
The holding member according to (1),
wherein the handle has a shape by which the user is able to visually or haptically recognize an attitude of the holding member.
(3)
The holding member according to (2),
wherein the handle includes a portion whose outer shape or cross-sectional shape has a longitudinal direction.
(4)
The holding member according to (2) or (3),
wherein the handle includes a portion whose outer shape or cross-sectional shape is rectangular or oval.
(5)
The holding member according to (2),
wherein the longitudinal direction is identical to a top-bottom direction of the small imaging device in a state in which the holding member is attached to the small imaging device.
(6)
The holding member according to (2),
wherein the longitudinal direction is identical to a direction perpendicular to a top-bottom direction of the small imaging device in a state in which the holding member is attached to the small imaging device.
(7)
The holding member according to any one of (1) to (6),
wherein the handle includes a pillar protruding from the coupling part.
(8)
The holding member according to (7),
wherein the handle includes a flange continuing into the pillar on an opposite side of the coupling part.
(9)
The holding member according to (8),
wherein the coupling part and the flange are not parallel when the holding member is viewed from a predetermined direction intersecting a direction in which the pillar extends.
(10)
The holding member according to (9),
wherein a space between the coupling part and the flange spreads from an upper side toward a lower side in a top-bottom direction of the small imaging device, in a state in which the holding member is attached to the small imaging device.
(11)
The holding member according to any one of (1) to (6),
wherein the handle includes a pillar that protrudes from the coupling part and whose outer shape or cross-sectional shape has a longitudinal direction, and a flange that continues from the pillar on an opposite side of the coupling part and whose outer shape or cross-sectional shape has a longitudinal direction, the longitudinal direction of the pillar being identical to the longitudinal direction of the flange.
(12)
The holding member according to (11),
wherein the longitudinal direction of the pillar and the flange is identical to a top-bottom direction of the small imaging device in a state in which the holding member is attached to the small imaging device.
(13)
The holding member according to (2) or (3),
wherein the handle is connected to the coupling part via a bent part.
(14)
The holding member according to (2) or (3),
wherein the handle includes a ring-shaped portion.
(15)
The holding member according to any one of (1) to (14),
wherein an outer shape of the coupling part is identical to an outer shape of a surface of the small imaging device to which the holding member is attached.
(16)
The holding member according to any one of (1) to (15),
wherein a rubber part formed of soft material covers at least a part of a surface of a hard part formed of hard material.
(17)
The holding member according to any one of (1) to (16),
wherein the holding member is coupled with a cylindrical small camera that is the small imaging device.
(18)
An imaging unit including:
a small imaging device; and
a holding member including a coupling part coupled with the small imaging device, and a handle to be gripped by a user.
(19)
The imaging unit according to (18),
wherein an outer shape or a cross-sectional shape of the handle has a longitudinal direction identical to a top-bottom direction of the small imaging device.
(20)
The imaging unit according to (18) or (19),
wherein the small imaging device is a cylindrical small camera.

### REFERENCE SIGNS LIST

10, 110, 210, 310, 410 holding member
12 hard part
14 rubber part
20, 120, 220, 320, 420 coupling part
20a end surface
23 groove
26 engagement claw
30, 130, 230, 330, 430 handle
40 pillar
60 flange
80 lens-style camera (small camera)
140, 240 bent part
265 protrusion
280 housing
335, 435 opening
340, 440 base

1. A holding member comprising:
a coupling part configured to be coupled with a small imaging device; and
a handle configured to be gripped by a user.

2. The holding member according to claim 1,
wherein the handle has a shape by which the user is able to visually or haptically recognize an attitude of the holding member.

3. The holding member according to claim 2,
wherein the handle includes a portion whose outer shape or cross-sectional shape has a longitudinal direction.

4. The holding member according to claim 2,
wherein the handle includes a portion whose outer shape or cross-sectional shape is rectangular or oval.

5. The holding member according to claim 3,
wherein the longitudinal direction is identical to a top-bottom direction of the small imaging device in a state in which the holding member is attached to the small imaging device.

6. The holding member according to claim 3,
wherein the longitudinal direction is identical to a direction perpendicular to a top-bottom direction of the small imaging device in a state in which the holding member is attached to the small imaging device.

7. The holding member according to claim 1,
wherein the handle includes a pillar protruding from the coupling part.

8. The holding member according to claim 7,
wherein the handle includes a flange continuing into the pillar on an opposite side of the coupling part.

9. The holding member according to claim 8,
wherein the coupling part and the flange are not parallel when the holding member is viewed from a predetermined direction intersecting a direction in which the pillar extends.

10. The holding member according to claim 9,
wherein a space between the coupling part and the flange spreads from an upper side toward a lower side in a top-bottom direction of the small imaging device, in a state in which the holding member is attached to the small imaging device.

11. The holding member according to claim 1,
wherein the handle includes a pillar that protrudes from the coupling part and whose outer shape or cross-sectional shape has a longitudinal direction, and a flange that continues from the pillar on an opposite side of the coupling part and whose outer shape or cross-sectional shape has a longitudinal direction, the longitudinal direction of the pillar being identical to the longitudinal direction of the flange.

12. The holding member according to claim 11,
wherein the longitudinal direction of the pillar and the flange is identical to a top-bottom direction of the small imaging device in a state in which the holding member is attached to the small imaging device.

13. The holding member according to claim 2,
wherein the handle is connected to the coupling part via a bent part.

14. The holding member according to claim 2,
wherein the handle includes a ring-shaped portion.

15. The holding member according to claim 1,
wherein an outer shape of the coupling part is identical to an outer shape of a surface of the small imaging device to which the holding member is attached.

16. The holding member according to claim 1,
wherein a rubber part formed of soft material covers at least a part of a surface of a hard part formed of hard material.

17. The holding member according to claim 1,
wherein the holding member is coupled with a cylindrical small camera that is the small imaging device.

18. An imaging unit comprising:
a small imaging device; and
a holding member including a coupling part coupled with the small imaging device, and a handle to be gripped by a user.

19. The imaging unit according to claim 18,
wherein an outer shape or a cross-sectional shape of the handle has a longitudinal direction identical to a top-bottom direction of the small imaging device.

20. The imaging unit according to claim 18,
wherein the small imaging device is a cylindrical small camera.
